(19) United States
(12) Patent Application Publication
(10) Pub. No.: US 2026/0177718 A1
(43) Pub. Date: Jun. 25, 2026

(54) METHOD TO CREATE A DIP-CONSTRAINED PSEUDO ANGLE COMMON-IMAGE GATHER

(71) Applicant: SAUDI ARABIAN OIL COMPANY, Dhahran (SA)

(72) Inventor: Lu Liu, Beijing (CN)

(73) Assignee: SAUDI ARABIAN OIL COMPANY, Dhahran (SA)

(21) Appl. No.: 19/128,344

(22) PCT Filed: Nov. 23, 2022
(86) PCT No.: PCT/CN2022/133712

§ 371 Date: May 8, 2025

(51) Int. Cl. G01V 1/30; E21B 44/00; G01V 1/34

(52) U.S. Cl. CPC G01V 1/303; E21B 44/00; G01V 1/301; G01V 1/34

(57) ABSTRACT

Systems and methods for creating a plurality of dip-constrained pseudo-angle common image gathers (DPACIGs) to pick a residual moveout are disclosed. The method includes obtaining a plurality of plane-wave CIGs and an initial seismic velocity model, stacking the plane-wave CIGs to estimate a structural dip and applying a vector median filter (VMF) to attenuate a dip noise contained in the structural dip. The method also includes smoothing the plurality of plane-wave CIGs by applying a structural oriented smoothing (SOS) to create a plurality of dip-constrained plane-wave CIGs and applying a non-linear transform to the plurality of dip-constrained plane-wave CIGs to create a plurality of DPACIGs. The method further includes performing a migration velocity analysis (MVA) on the DPACIGs to pick a residual moveout, determining an updated seismic velocity model based on the residual moveout and creating a seismic image using the updated seismic velocity model and the seismic dataset.

### BACKGROUND

Seismic surveys are frequently conducted by participants in the oil and gas industry. Seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series of samples recorded at many receiver locations generated by a seismic source at many source locations constitutes a seismic data set.

To determine earth structure, including the presence of hydrocarbons, the seismic data set may be processed. Processing a seismic dataset includes a sequence of steps designed to correct for near-surface effects, attenuate noise, compensate of irregularities in the seismic survey geometry, calculate a seismic velocity model, image reflectors in the subterranean and calculate a plurality of seismic attributes to characterize the subterranean region of interest to determine a drilling target. Critical steps in processing seismic data include a seismic migration. Seismic migration is a process by which seismic events are re-located in either space or time to their true subsurface positions. Many different migration techniques may be used including plane-wave migrations which may produce plane-wave common image gathers (CIGs). Migration velocity analysis (MVA) may be performed on these plane-wave CIGs to update or correct the seismic velocity model used in the plane-wave migration in order to better image the subsurface. A seismic image for the subterranean region of interest may be created based, at least in part, on the updated seismic velocity model. A properly processed seismic dataset may aid in decisions as to if and where to drill for hydrocarbons, based at least in part, on the seismic image.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for creating a plurality of dip-constrained pseudo-angle common image gathers (DPACIGs) to pick a residual moveout. The method includes obtaining a plurality of plane-wave CIGs and an initial seismic velocity model, stacking the plane-wave CIGs to estimate a structural dip and applying a vector median filter (VMF) to attenuate a dip noise contained in the structural dip. The method also includes smoothing the plurality of plane-wave CIGs by applying a structural oriented smoothing (SOS) to create a plurality of dip-constrained plane-wave CIGs and applying a non-linear transform to the plurality of dip-constrained plane-wave CIGs to create a plurality of DPACIGs. The method further includes performing a migration velocity analysis (MVA) on the DPACIGs to pick a residual moveout, determining an updated seismic velocity model based on the residual moveout and creating a seismic image using the updated seismic velocity model and the seismic dataset.

In general, in one aspect, embodiments relate to a system that includes a seismic survey system configured to acquire a seismic dataset for a subterranean region of interest, a seismic processor and a seismic interpretation workstation. The seismic processor is configured to receive the seismic dataset composed of a plurality of plane-wave CIGs from the seismic acquisition system and an initial seismic velocity model for the subterranean region of interest. The seismic processor is further configured to stack the plurality of plane-wave CIGs to estimate a structural dip, apply a vector median filter (VMF) to attenuate a dip noise contained in the structural dip, smooth the plurality of plane-wave CIGs by applying a structural oriented smoothing (SOS) to create a plurality of dip-constrained plane-wave CIGs and apply a non-linear transform from a plane-index to a pseudo-angle index to the plurality of dip-constrained plane-wave CIGs to create a plurality of DPACIGs. The seismic processor is further configured to perform a migration velocity analysis (MVA) on the DPACIGs to pick a residual, determine an updated seismic velocity model based on the residual moveout and create a seismic image for the subterranean region of interest using the updated seismic velocity model and the seismic dataset. The system also includes a seismic interpretation workstation configured to identify a drilling target within the subterranean region of interest based on the seismic image.

In general, in one aspect, embodiments relate to a non-transitory computer readable memory having computer-executable instructions stored thereon that, when executed by a processor, perform steps for creating a plurality of DPACIGS to pick a residual moveout. The steps include obtaining a seismic dataset for a subterranean region of interest composed of a plurality of plane-wave CIGs and an initial seismic velocity model, stacking the plane-wave CIGs to estimate a structural dip and applying a vector median filter (VMF) to attenuate a dip noise contained in the structural dip. The steps also include smoothing the plurality of plane-wave CIGs by applying a structural oriented smoothing (SOS) to create a plurality of dip-constrained plane-wave CIGs and applying a non-linear transform to the plurality of dip-constrained plane-wave CIGs to create a plurality of DPACIGs. The steps further include performing a migration velocity analysis (MVA) on the DPACIGs to pick a residual moveout, determining an updated seismic velocity model based on the residual moveout and creating a seismic image using the updated seismic velocity model and the seismic dataset. The instructions still further include identifying a drilling target within the subterranean region of interest based on the seismic image.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic survey in accordance with one or more embodiments.

FIGS. 2A-2E show seismic gathers in accordance with one or more embodiments.

FIGS. 3A-3B show seismic images in accordance with one or more embodiments.

FIGS. 4A-4B show dip fields in accordance with one or more embodiments.

FIGS. 5A-SB show seismic images in accordance with one or more embodiments.

FIGS. 6A-6B show seismic gathers in accordance with one or more embodiments

FIG. 7 shows a flowchart in accordance with one or more embodiments.

FIGS. 8A-8F show seismic gathers in accordance with one or more embodiments.

FIGS. 9A-9C show seismic gathers in accordance with one or more embodiments.

FIG. 10 shows a drilling system in accordance with one or more embodiments.

FIG. 11 shows a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

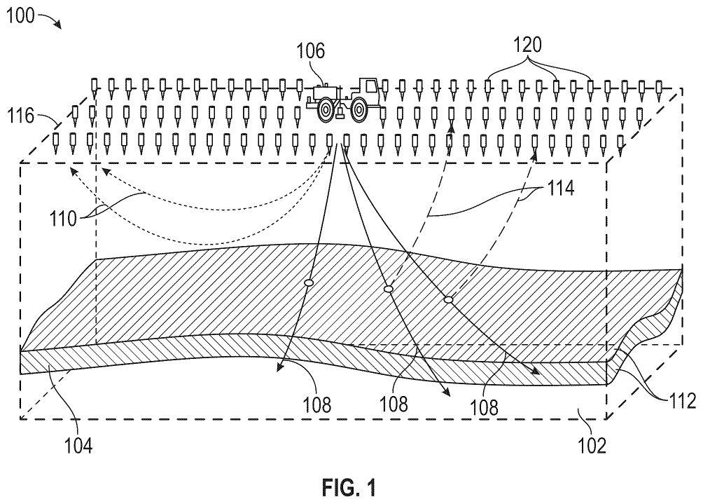

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic data set” includes reference to one or more of such seismic data set.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

The term “seismic data” or “seismic dataset” as used herein broadly means any data received and/or recorded as part of the seismic surveying process, including particle displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or properties, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying process. Thus, this disclosure may at times refer to “seismic data and/or data derived therefrom,” or equivalently simply to “seismic data.” Both terms are intended to include both measured/recorded seismic data and such derived data, unless the context clearly indicates that only one or the other is intended.

The terms “seismic velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes. For example, the spatial distribution of velocity may be modeled using constant-velocity units (layers) through which is ray paths obeying Snell's law can be traced.

A seismic velocity model represents the seismic velocity or the speed with which a seismic wave propagates through a subsurface material. Different subsurface materials may exhibit different seismic velocities. A seismic velocity model may be determined from a seismic dataset using a variety of methods, known to a person of ordinary skill in the art, collectively called “velocity analysis” or “migration velocity analysis (MVA)”.

Seismic noise may be any unwanted recorded energy that is present in a seismic data set. Seismic noise may be random or coherent and its removal, or “denoising,” is desirable in order to improve the accuracy and resolution of the seismic image. For example, seismic noise may include, without limitation, swell, wind, traffic, seismic interference, mud roll and ground roll. A properly processed seismic data set may aid in decisions as to if and where to drill for hydrocarbons.

The embodiments disclosed herein describe methods and systems for creating dip-constrained pseudo-angle common image gathers (DPACIGs) from a seismic dataset in order to perform MVA and update a seismic velocity model. The methods include stacking a plurality of plane-wave CIGs to estimate a structural dip and applying a vector median filter (VMF) to attenuate a dip noise contained in the structural dip. The method further includes smoothing the plurality of plane-wave CIGs by applying a structural oriented smoothing (SOS) to create a plurality of dip-constrained plane-wave CIGs. The dip-constrained plane-wave CIGs are transformed by applying a non-linear transform from the plane-index to a pseudo-angle index to create a plurality of DPACIGs. The DPACIGS may be advantageous to performing a MVA to pick a residual moveout. An updated seismic velocity model may be determined based on the residual moveout and a seismic image for the subterranean region of interest may be created using the updated seismic velocity model and the seismic dataset. A drilling target may be determined based on the interpretation of the seismic image using a seismic interpretation workstation and a wellbore path may be planned, using a wellbore path planning system, to intersect the drilling target. A wellbore may then be drilled guided by the wellbore path using a drilling system, in accordance with one or more embodiments.

FIG. 1 shows a seismic survey (100) of a subterranean region of interest (102), which may contain a hydrocarbon reservoir (104). The seismic survey (100) may utilize a seismic source (106) on the surface of the earth (116) that generates radiated seismic waves (108). The radiated seismic waves (108) may return to the surface as refracted seismic waves (110) or may be reflected by geological discontinuities (112) and return to the surface as reflected seismic waves (114). At the surface, the refracted seismic waves (110) and reflected seismic waves (114) may be detected by seismic receivers (120).

In some embodiments, the refracted seismic waves (110) and reflected seismic waves (114) generated by a single activation of the seismic source (106) are recorded by a seismic receiver (120) as a time-series representing the amplitude of ground-motion at a sequence of discreet times. This time-series may be denoted a seismic “trace”. The seismic receivers (120) are positioned at a plurality of seismic receiver locations that we may denote (xᵣ, yᵣ) where x and y represent orthogonal axes on the surface of the earth (116) above the subterranean region of interest (102). Thus, the refracted seismic waves (110) and reflected seismic waves (114) generated by a single activation of the seismic source (106) may be represented as a three-dimensional “3D” volume with axes (xᵣ, yᵣ, t) where (xᵣ, yᵣ) represents the location of the seismic receiver (120) and t delimits the time sample at which the amplitude of ground-motion was measured.

A seismic survey (100) also may include recordings of seismic waves generated by a seismic source (106) that is positioned at a plurality of seismic source locations denoted (xₛ, yₛ). Thus, all the data acquired by a seismic survey (100) may be represented as a five-dimensional volume, with coordinate axes (xₛ, yₛ, xᵣ, yᵣ, t) and denoted a “seismic data set”.

A seismic data set must be processed to generate a seismic velocity model of the subterranean region of interest (102) or an image of seismic reflectors within the subterranean region of interest (102). Seismic reflectors may be of the geological boundaries, such as the boundaries between geological layers, the boundaries between different pore fluids, faults, fractures or groups of fractures within the rock.

Processing a seismic data set comprises a sequence of steps designed, without limitation, to do one or more of the following: correct for near surface effects; attenuate noise; compensate for irregularities in the seismic survey geometry; calculate a seismic velocity model; image reflectors in the subsurface; calculate a plurality of seismic attributes to characterize the subterranean region of interest (102); and aid in decisions governing where to drill for hydrocarbons. Processing a seismic dataset may also include a seismic migration, in which seismic events are re-located in either space or time to their true subsurface positions using a seismic dataset and a seismic velocity model.

In seismic processing, it is common practice to sort the seismic dataset into different arrangements, termed seismic gathers, in order to perform a particular seismic process more advantageously. A seismic gather is a collection of seismic traces that are sorted as to share a common seismic attribute, such as a common source location, or a common source-receiver midpoint. Different gathers may be used to examine the variability of amplitude, signal to noise ratio (S/N), move-out, frequency content, phase and other seismic attributes.

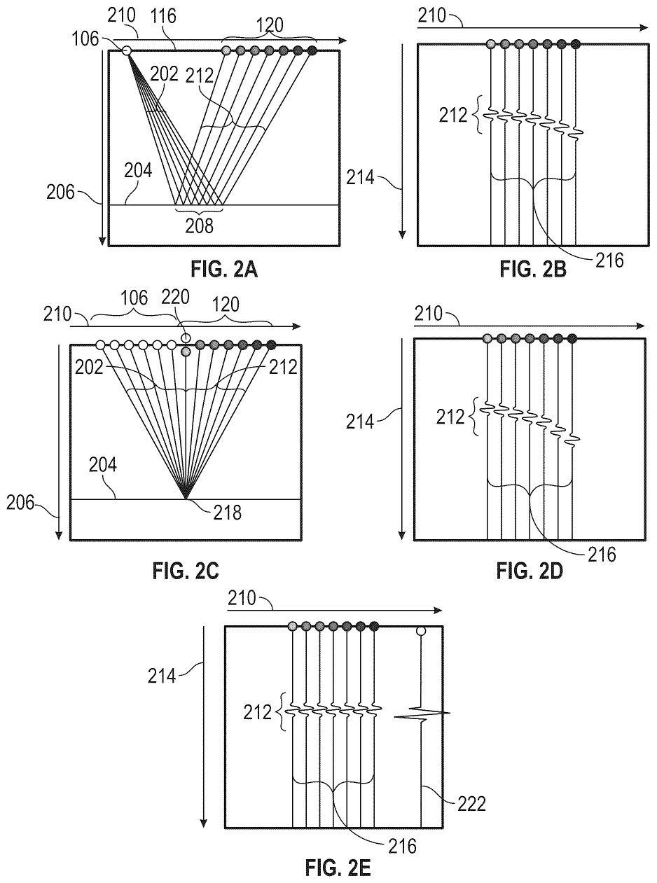

FIGS. 2A-2E depicts various seismic gathers, in accordance with one or more embodiments. FIG. 2A depicts seismic waves (202) radiating from a seismic source (106), reflecting from a seismic reflector (204) at a depth indicated by the vertical axis (206) and a plurality of horizontal reflection points (208), propagating as seismic reflections (212) back to the surface of the earth (116) and being recorded by an array of seismic receivers (120) covering a range of offsets (210) indicated by the horizontal axis. FIG. 2A depicts the acquisition geometry for recording a shot gather or a common shot gather (CSG), depicted in FIG. 2B.

FIG. 2B depicts the plurality of seismic traces (216) recorded by the array of seismic receivers (120). These seismic traces (216), originating from a single seismic source location (x̅ₛ, y̅ₛ), maybe denoted D (t, xᵣ, yᵣ, x̅ₛ, y̅ₛ) and may be called a “common source gather” or a “common shot gather (CSG)”. The seismic reflections (212) may be detected on traces within a CSG at two-way travel times, indicated on the vertical axis (214), that increase as the distance between the seismic source and the receiver, typically called “offset” (210) and indicated on the horizontal axis (210) increases. This phenomenon of increasing two-way travel time with offset is often called “moveout”.

FIG. 2C depicts the arrangement a common-midpoint (CMP) gather, in accordance with one or more embodiments. FIG. 2C depicts seismic waves (202) radiating from a plurality of seismic sources (106), reflecting from a seismic reflector (204) at a depth indicated by the vertical axis (206). This single reflection point (218) of the seismic waves occurs at the same point on the seismic reflector (204) for all traces in the CMP gather. Seismic reflections (212) propagate back to the surface of the earth (116) from this single reflection point (218) and are recorded by an array of seismic receivers (120) at an increasing offset (210) indicated by the horizontal axis. The seismic sources (106) and the seismic receivers (120) shown are selected to have a common midpoint (220), i.e., the point on the surface halfway between the seismic source (106) and seismic receiver (120) that is shared by all the selected seismic source-seismic receiver pairs. In practice, due to spatial irregularities in the seismic source (106) and seismic receiver (120) geometry, the halfway point of the selected seismic source (106) and seismic receiver (120) may not be identical but rather lie within a small range (“bin”) of spatial locations. Such an arrangement of selected seismic data may be called a “common midpoint (CMP) gather”. In many cases, a common midpoint gather may be more convenient than a CSG because the reflection point of the seismic waves occurs at the same point (218), or very closely spaced points, on the seismic reflector for all traces in the common-midpoint gather.

FIG. 2D depicts the plurality of seismic traces (216) of a CMP gather. The traces in a CMP gather may be denoted D (t, xₒ+x̅ₘ, yₒ+y̅ₘ, xₒ−x̅ₘ, yₒ−y̅ₘ), where (x̅ₘ, y̅ₘ) is the location of the midpoint and (x̅ₒ, y̅ₒ) are vectors of offsets in the x- and y-directions. The seismic reflections (212) detected on seismic traces in a midpoint gather also exhibit two-way travel time. The two-way travel time of seismic reflections (212) detected on seismic traces may be said to form a “pre-stack horizon” at an increasing two-way travel time, indicated on the vertical axis (214), and at an increasing offset (210) indicated by the horizontal axis, t_{A}(xₒ+x̅ₘ, yₒ+y̅ₘ, xₒ−x̅ₘ, yₒ−y̅ₘ). CMP gathers are widely used in velocity analysis, to perform a moveout corrections. The seismic reflections (212) may be “flattened” or moveout corrected, by picking a seismic velocity model which results in a flattened pre-stack horizon, shown in FIG. 2E.

FIG. 2E shows a pre-stack CMP gather after a correction for two-way travel time moveout. After a correction for two-way travel time moveout, all of the seismic reflections (212) depicted on seismic traces form a single, flat seismic reflector arriving at the same moveout-corrected time indicated by the vertical axis (214) as the offset (210) of the detecting receiver increases along the horizontal axis. The corrected seismic traces (216) may be summed (“stacked”) to form a post-stack seismic trace (222). Stacking is an essential part of seismic data processing, and the resulting post-stack seismic trace (222) may have a higher signal-to-noise ratio than traces in the CMP gather as random noise attenuated.

Following common practice, it is convenient to illustrate some of the concepts disclosed herein using synthetic seismic data generated by solving seismic wave propagation equations. Synthetic seismic data is advantageous for this purpose because it may be calculated for simplified and known models of the subsurface of the earth and contain zero or specified levels of noise. Later in this disclosure the results of applying the methods described herein to real seismic data are shown. In either case, all of the tests performed in the following application to create the plane-wave images and plane-wave CIGs are resulting from a plane-wave depth migration, therefore the vertical axis will all represent depth. In some embodiments, a plane-wave time migration may be used to create the plane-wave images and plane-wave CIGs and in that case, the vertical axis would represent time.

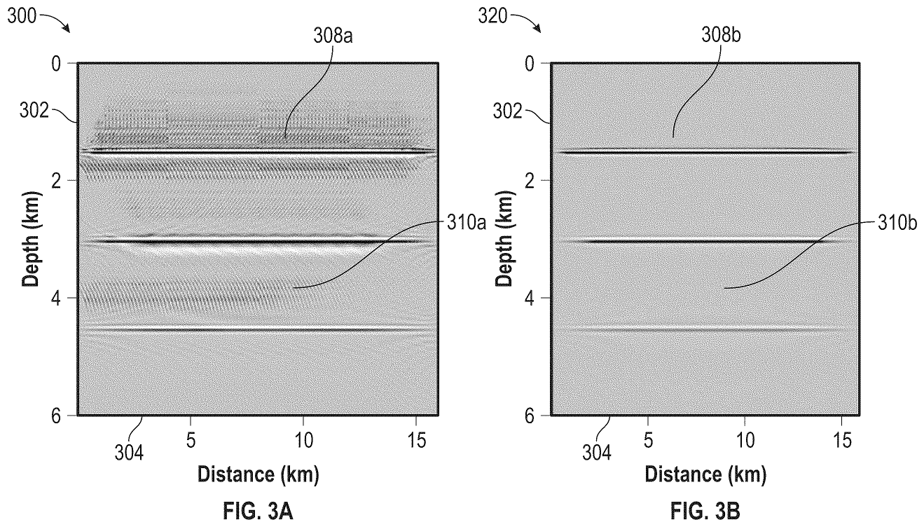

FIGS. 3A and 3B show synthetic seismic data for a simple model containing four layers each separated by a reflective boundary at which a portion of an incident seismic wave is reflected. Specifically, 100 CSGs were generated with a lateral homogeneous velocity model with three flat layers and a plane-wave migration was performed using the lateral homogenous velocity model. A plane-wave migration includes combining multiple CSGs into a composite plane-wave gather and then migrating the plane-wave gathers with different ray parameters to obtain plane-wave images. The number of plane waves migrated in a plane-wave migration is typically much smaller than the number of CSGs in the seismic dataset and may reduce the computational and memory cost when compared to other types of seismic migrations.

Both FIGS. 3A and 3B illustrate seismic reflections at a horizontal location indicated by the horizontal axis (304). In some embodiments, the vertical axis (302) may represent time (measured from the activation of a seismic source) and each sample may contain a measurement of ground vibration caused by a seismic wave at the corresponding time. In other embodiments, the vertical axis (302) may represent depth (measured from a datum that may be a point on the surface of the earth or mean sea-level) and each sample may contain an estimate of seismic wave reflection amplitude at the corresponding depth.

A plane-wave image (300) resulting from a depth plane-wave migration, having a single plane-wave with a surface incident angle of 28° is shown in FIG. 3A. The surface incidence angle, also referred to as the ray parameter, describes the acute angle at which a seismic wave impinges upon a seismic reflector. Plane-wave images may suffer from a lower signal-to-noise (S/N) ratio and an increase in cross-term artifacts compared to other types of seismic images. Plane-wave images may also suffer from aliasing artifacts due to under sampling. Seismic data may be under-sampled if the sampling rate is less than twice the highest frequency of the recorded signal, or the Nyquist rate. Aliasing artifacts are shown in FIG. 3A (208a, 210a) at two different depths. These artifacts (308a, 310a) in plane-wave images might bias the extraction of the moveout information, making MVA difficult. In addition to these potential disadvantages, plane-wave images may have narrow illumination at greater depths.

FIG. 3B shows a stacked plane-wave image (320) was created by “stacking” or summing 40 plane-wave images having a surface incident angle that ranges from −28°-28°. Stacking the 40 plane-wave images over a range of surface incident angles may attenuate random noise and artifacts while simultaneously amplifying the coherent signal. The aliasing artifacts (308a, 310a) seen in FIG. 3A, have been eliminated or greatly reduced when comparing the same locations in FIG. 3B (308b, 310b). FIG. 3B illustrates that it is possible to exploit the structure information from a stacked image, to improve the quality of each individual plane-wave image (300). For example, a stacked plane-wave image (320) may be advantageous to determining a structural dip of a seismic event without the contamination from aliasing or cross term artifacts (308a, 310a).

One way to exploit the structural dip from the stacked image is by computing a structure tensor. A structural dip may be represented as a vector valued local slope of a seismic event and a vector valued dip noise.

The structure tensor T may be determined by calculating a gradient vector of a 2×2 symmetric positive-semi-definite matrix composed of the vertical and horizontal gradients of the stacked plane-wave images. λᵤ and λ_{y} are set as the eigenvalues corresponding to the eigenvectors u and v of T. Because the structure tensor Tis positive-semi-definite, its eigenvalues are greater than or equal to zero or λᵤ≥λᵥ≥0, and the eigenvector u is perpendicular to the locally linear features in the seismic image, or the structural dip. The eigenvector v is parallel to such features so the computed eigenvector represents the normal direction of a seismic event at the location, or the structural dip. The structural tensor method may result in erratic dips, especially in areas where the S/N ratio is low. This potential disadvantage of using the structural tensor method has been reduced by computing the structural tensor on the stacked image with an increased S/N ratio instead of the individual plane-wave images.

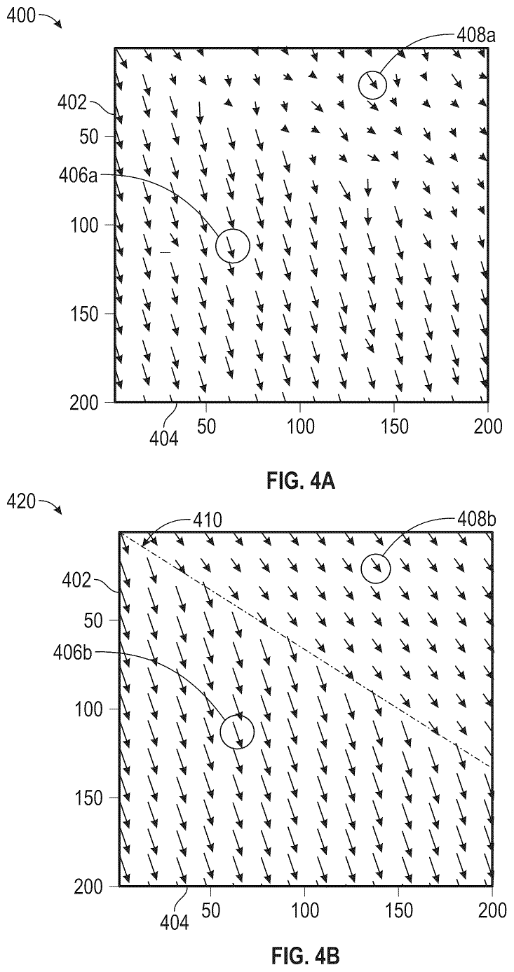

FIGS. 4A and 4B show seismic dip fields in accordance with one or more embodiments. Many different attributes from a seismic dataset may be represented as vectors such as seismic wave-fields, dips and azimuths of seismic events, and calculated move-out slopes in migrated CIGs. Specifically, FIG. 4A shows a structural dip that consists of a vector valued local slope representing a seismic event and an added vector valued dip noise. The structural dip may be estimated according to a stack of numerous plane-wave images covering a range of surface incidence angles, such as stacked plane-wave image (320) shown in FIG. 3B. Both FIGS. 4A and 4B illustrate the vector valued structural dip at a time or depth indicated by the vertical axis (402) and at a horizontal location indicated by the horizontal axis (404). In this case, FIGS. 4A and 4B are not true dip fields computed from a stacked image, rather they are a synthetically created dip fields to illustrate the effectiveness a vector median filter may have to remove dip noise and other anomalies from a vector valued structural dip.

It is often advantageous in seismic processing to apply some form of noise attenuation to a seismic dip field in order to remove a dip noise. For example, due to noise, a smoothly dipping reflector may appear in a seismic image with small amplitude but rapidly varying undulations (ripples) or discontinuities (steps) superimposed on the smooth dip. Removing the dip noise may improve the orientation of the structural dip of a seismic event and may be advantageous to subsequent seismic processes.

For example, a vector median filter (VMF) may be used to remove dip noise and other anomalies from a seismic dip field represented by a group of vectors X={x₀, x₁, . . . , xᵢ, . . . , x_{N}}. Applying a VMF to attenuate the dip noise contained in the structural dip may include solving a recursive algorithm within a window in accordance with one or more embodiments. The window may be a time or depth window and may be predefined by a user. The output z of VMF, is a vector median, which has the minimum distance to all data vectors within the window and is defined by:

$$z = \begin{matrix}argmin \\ {x}_{m} ∈ {x}_{l}\end{matrix} {\sum }_{i = 0}^{N} {‖ {x}_{i} - {x}_{m} ‖}_{L ,} \qquad Equation ( 1 )$$

where L is the vector norm and ∥xᵢ−xₘ∥_{L} measures the distance between vector xᵢ and vector xₘ and z is the output vector median. Equation (1) may be solved via a recursive algorithm, such as the fast VMF algorithm proposed by Astola et al. (1990), within a window. The window may be a sliding window, moving to a separate adjacent location to determine a new median vector z, until the full extent of the seismic image has been covered. A number of vectors are collected within this sliding window and the median vector defined by Equation (1) is chosen and applied to the middle location or point at the center of the window. The window then moves to an adjacent location to repeat the process. In some cases, the window may include overlap between adjacent locations, while in other cases the window may be contiguous but not overlapping. In some cases, two overlapping windows may have all but two points in common, while in other cases the overlapping windows may have fewer points in common.

To illustrate the effectiveness of a VMF, a vector dip field (400) is displayed in FIG. 4A. The vector dip field is composed of two constant vectors (406a, 408a) plus additional additive random noise. Notice, the two constant vectors (406a,408a) are different from one another in direction and amplitude, and the addition of random noise produces an irregular spatial variation of the dip vectors over the field (400). The two constant vectors (406a, 408a) are primarily masked by the dip noise and the true orientation of the vector dip field (400) is difficult to determine.

To attenuate this dip noise and improve the orientation of the vector valued structural dips, a VMF is applied to the dip field (400) and the resulting dip field (420) is displayed in FIG. 4B. The resulting dip field (420) shows an elimination or a significant reduction in the random variation of the vector valued structural dips. The VMF process will not output a vector that does not exists in the original input data and the two underlying constant vectors (408b, 408b) are now revealed in the resulting dip field (420). Two distinct dip field orientations may be observed when looking at the resulting dip field (420), with the upper right portion containing a vector valued structural dip representative of the underlying constant vector (408b) and the bottom left portion containing a vector valued structural dip representative of the underlying constant vector (406b). A sharp transition between the two distinct portions along the line (410) running from the top left portion to the lower right portion of FIG. 4B has been preserved. This sharp transition, indicated by the line (410) may indicate the presence of a seismic reflector along the line. The resulting structural dip (420) displays a greater continuity in structural dip and a greatly reduced dip noise which may be advantageous in subsequent seismic processing steps.

In some embodiments, a vector valued structural dip, such as the vector median output z from a VMF application, may further be used to improve a seismic image. One common technique used in seismic processing that smooths an image along a guidance structure, such as a structural dip, is structural oriented smoothing (SOS). SOS performed on a seismic image may enhance the structural features while preserving important discontinuities such as faults. SOS may be performed by solving the anisotropic diffusion equation using the estimated structural dip. The anisotropic diffusion equation (Hale, Dave. 2009. Structure-oriented smoothing and semblance. CWP report, 635:261-270) is defined by:

$$g ( x ) - α ∇ \cdot D ( x ) ∇ g ( x ) = f ( x ) , \qquad Equation ( 2 )$$

where f(x) represents the input image, g(x) is the output smoothed image, α is the constant parameter controlling the level of smoothness and D is the tensor field which shares the same eigenvectors with the structural tensor T. The tensor field D may be determined from the vector median output z of VMF by examining their relationships in vector form. The output from VMF and the structure tensor are both a vector which describes a dip at a single point, for example one dip in a 2D case may be expressed as a vector of [v₁, v₂], and the resulted dip angle is computed via

$${tan}^{- 1} ( \frac{{v}_{2}}{{v}_{1}} ) .$$

Then tensor D may be then expressed as

$$[ \begin{matrix}{v}_{1}^{2} & {v}_{1} {v}_{2} \\ {v}_{1} {v}_{2} & {v}_{2}^{2}\end{matrix} ] ,$$

determined from the vector median output z of VMF. A big a leads to a heavily smoothed image, and α=0 implies g(x)=f(x) meaning no smoothing is performed. The user may control the level of smoothness dependent on the seismic dataset including S/N ratio and the structural dip.

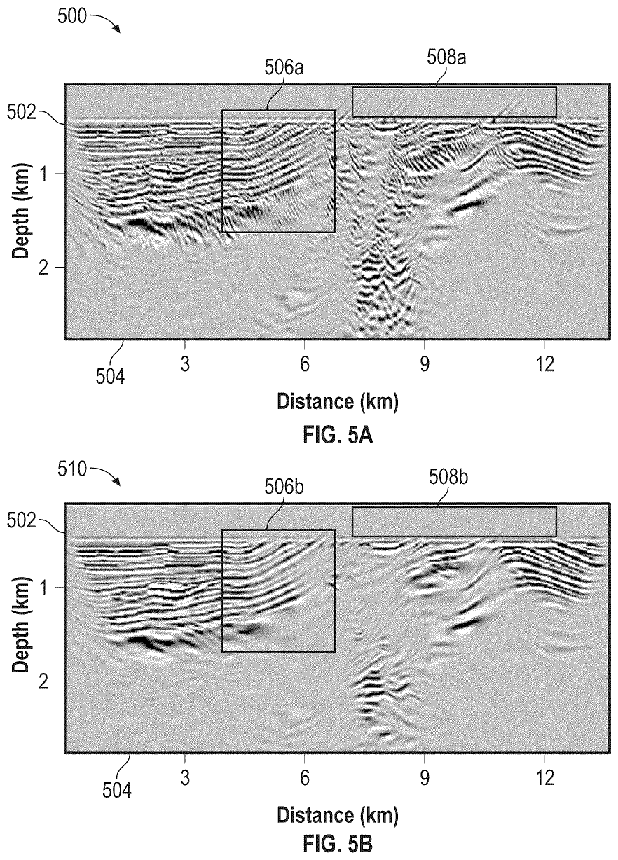

FIGS. 5A and 5B illustrate a migrated section (500) for one plane-wave gather with a surface incident angle of 28.6°. The migrated section (500) is displayed as a function of horizontal location indicated by the horizontal axis (504) and at a depth indicated by the vertical axis (502). This migrated section (500) shows seismic reflections at a variety of horizontal locations and depths. No additional seismic processing has been performed on the migrated section (500). The migrated section (500) displays a low S/N ratio, due to aliasing artifacts and conflicting dipping events, which are partially highlighted by the two boxes (506a, 508a). It is difficult to determine coherent seismic reflections in migrated section (500) as the noise and artifacts mask the true structural information. These artifacts and noise may hinder or bias the extraction of the moveout information, making MVA unreliable and challenging in areas such as (506a, 508a).

FIG. 5B illustrates the migrated section (510) from FIG. 5A, with the addition of an application of SOS. With the addition of SOS to the migrated section (510) shows and improved S/N ratio compares to migrated section (500) including a great reduction in aliasing artifacts throughout, particularly within boxes (506b, 508b) in comparison with boxes (506a, 508a). The coherency of the seismic reflections has also improved in FIG. 5B. FIG. 5B illustrates that it is possible to enhance the structural features of a seismic image by solving the anisotropic diffusion equation using an estimated structural dip. The estimated structural dip may be processed to remove dip noise and other anomalies using VMF prior to the application of SOS. This comparison clearly demonstrates that using VMF and SOS together results in a significant improvement in the migrated section (510) over conventional techniques. The improvement includes superior suppression of artifacts, increase in S/N ratio and an improvement in the coherency of the seismic reflections.

In accordance with one or more embodiments, CIGs may be formed from the output of plane-wave migrations. Plane-wave CIGs reduce the computational cost of memory storage when compared to other extended domain CIGs because they are directly calculated from the plane-wave migration and the number of plane waves is often much smaller than the number of shots in the seismic dataset. Plane-wave migrations themselves require an assumed seismic velocity model of the subsurface and, thus, the plane-wave CIGs are dependent upon the choice of seismic velocity model. When a seismic velocity model is chosen that matches the true seismic velocity in the subsurface the resulting CIGs will present flat, i.e., invariant with respect to ray parameter, images. However, if the seismic velocity model deviates from the true seismic velocity in the subsurface the resulting CIG will be curved.

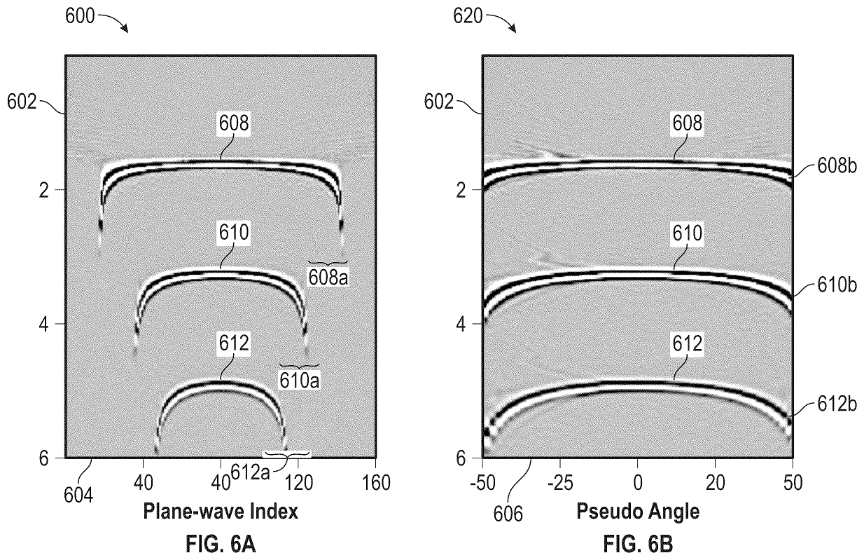

FIG. 6A illustrates a plane-wave CIG (600) generated for a synthetic seismic dataset with three reflectors (608, 610, 612) using a seismic velocity model where the seismic velocity model contains velocities that are 10% higher than the true velocity. A plane-wave CIG (600) is displayed on a vertical axis (602) indicating depth (km) and a horizontal axis (604) indicating ray parameter. As a result of the incorrect seismic velocities used for the plane-wave migration each of the three reflectors (608, 610, 612) are curved sharply at their extremities, e.g., (608a, 610a, 612a). Stacking, i.e., summing over ray parameter, the plane-wave CIGs, without first correcting the seismic velocities, can generate noise, including “aliasing noise” in the resulting seismic images. Furthermore, the rapid curvature exhibited at the extremities (608a, 610a, 612a) can make it difficult to identify the amount of curvature accurately and hence make updating the seismic velocity model problematic.

The plane-wave CIG (600) also illustrates a compression of reflections along the ray parameter axis with depth, which is characteristic of plane-wave CIGs. While seismic waves from a point source propagate with a wide range of ray parameters to shallow regions of the subsurface, only those propagating close to the vertical, i.e., with a narrow range of ray parameters close to zero, propagate to greater depths. As a result, deeper reflection, such as reflection (612), appear compressed along the ray parameter axis (604) when compared to shallower reflectors, such as reflector (608). The narrow range of ray parameters over which deeper reflectors appear may further exacerbate the problems of accurately identifying the amount of residual curvature and updating the seismic velocity model discussed in the previous paragraph.

In according to one or more embodiments, these challenges may be remedied by applying a non-linear transform to the ray-parameter values prior to display and further analysis of the plane-wave CIG (600). For example, a non-linear transform from a ray-parameter to a pseudo-angle α may be used to extend their coverage at increasing depths. The non-linear transform from a ray-parameter to a pseudo-angle α may base on the initial seismic velocity model and an application of Snell's Law defined by:

$$α ( z ) = asin ( \frac{sin ( {θ}_{0} ) {v}_{0}}{v ( z )} ) \qquad Equation ( 3 )$$

wherein α(z) is the pseudo-angle along depth, θ₀ is the surface incident angle, v₀ is the surface velocity, and v(z) is the interval velocity along depth determined from the original seismic velocity model.

Turning to FIG. 6B, a pseudo-angle (PA) CIG (620) is illustrated. The plane-wave CIG (600) has undergone a non-linear transform from the plane-index to a pseudo-angle index resulting in the PACIG (620) according to equation 3. The PACIG (620) is displayed on a vertical axis (602) indicating depth and a horizontal axis (606) indicating the pseudo-angle. The three horizontal reflectors (608, 610, 612) in the plane-wave CIG (600) that shows a rapid curvature exhibited at the extremities (608a, 610a, 612a) now exhibit much flatter and more coherent reflectors (608, 610, 612) in the PACIG (620), particularly in the areas at the extremities (608b, 610b, 612b). Furthermore, the degradation of coverage at increasing depths, demonstrated by the deepest reflector (615) of the plane-wave CIG (600) shows a great increase in coverage when comparing the same reflector (615) in the PACIG (620). The increased coherency of reflectors and the increased coverage at increasing depths may be advantageous for performing certain seismic processes including performing MVA to pick a residual moveout, particularly at increasing depths.

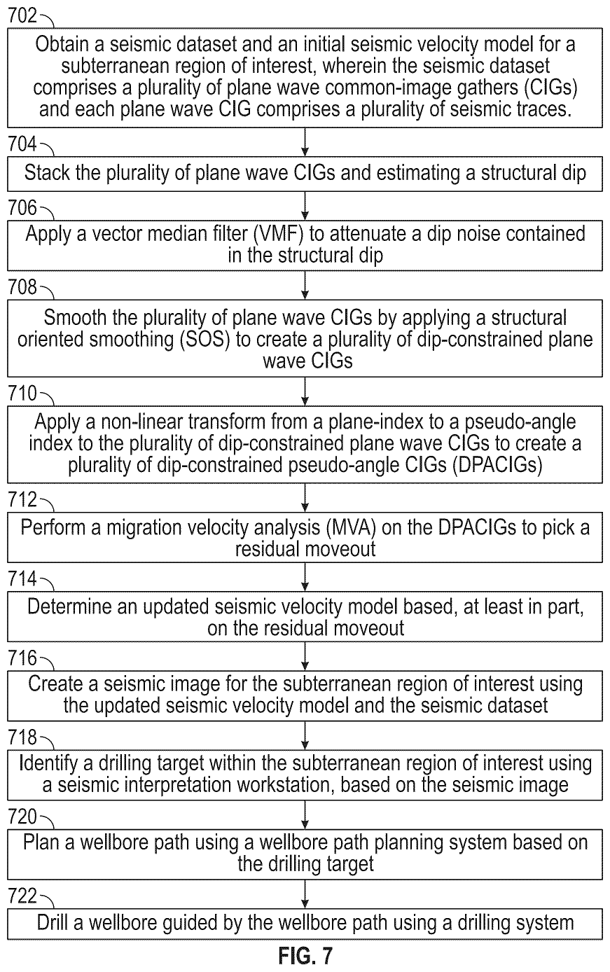

FIG. 7 shows a flowchart in accordance with one or more embodiments. The flowchart outlines a method to create dip-constrained pseudo angle common-image gathers (DPACIGs) to perform a migration velocity analysis (MVA) and to pick a residual moveout. The picked residual moveout resulting from the method described herein may be advantageous in determining an updated seismic velocity model and subsequently a seismic image for the subterranean region of interest. A drilling target may be identified within the subterranean region of interest based on the seismic image and a wellbore path may be planned using a wellbore path planning system to intersect the drilling target. A wellbore may be drilled guided by the wellbore path using a drilling system.

In Step 702, in accordance with one or more embodiments, a seismic dataset and an initial seismic velocity model for a subterranean region of interest is obtained. The seismic dataset may include a plurality of plane-wave CIGs and each plane-wave CIG may be composed of a plurality of seismic traces. In some embodiments, the available seismic dataset may require preconditioning to generate the plane-wave CIGs, including performing a seismic migration. In these embodiments, any number of seismic processing steps may be performed to the seismic dataset prior to creating the plane-wave CIGs, including noise attenuation processes, without deviating from the scope of this method. The plane-wave CIGs may be created from a plane-wave migration, using the initial seismic velocity model in accordance with one or more embodiments. A plane-wave CIG is illustrated in FIG. 6A in accordance with one or more embodiments. The initial seismic velocity model may be obtained from acoustic well logs or seismic datasets. The seismic velocity model may be obtained from a separate seismic dataset for the subterranean region of interest, or from a separate seismic dataset for an area approximate to the subterranean region of interest. The initial seismic velocity model may be obtained from any of the above methods, however the initial seismic velocity model should be the same seismic velocity model used in the plane-wave migration that produced the plane-wave CIGs.

In Step 704, in accordance with one or more embodiments, the plurality of plane-wave CIGs are stacked and a structural dip may be estimated. The structural dip may include a vector valued local slope of a seismic event and a vector valued dip noise. Estimating the structural dip may be performed by computing a structure tensor in accordance with one or more embodiments. Computing the structure tensor to determine a structural dip may result in erratic dips and particularity in areas with a low S/N ratio. To mitigate this potential disadvantage, the plane-wave CIGs are stacked together which reduces random noise and aliasing artifacts present in the plane-wave CIGs prior to determining the structural dip. This reduction of artifacts and other random noise may lead to an advantageous structural dip estimation by computing the structure tensor. FIG. 3B illustrates the benefit stacking may have for an image (300) to reduce artifacts and random noise.

In Step 706, in accordance with one or more embodiments, a vector median filter (VMF) may be applied to attenuate a dip noise contained in the structural dip. The application of the vector median filter (VMF) to attenuate the dip noise contained in the structural dip may include solving a recursive algorithm within a window. The recursive algorithm used to solve equation 1 and output a vector median vector representing the structural dip of a seismic event may include the fast VMF algorithm in some embodiments. The window may be a time or depth window and predefined by a user in accordance with one or more embodiments. The window may be a sliding window that moves to a separate adjacent location to apply the VMF, until the full extent of the seismic image has been covered.

By attenuating the dip noise contained in the structural dip, the resulting dip field output from VMF will demonstrate an increased coherency of the structural dip. FIG. 4B shows one example of a resulting dip field (420) after the application of a VMF and shows this increased coherency and dip noise removal. Any method known to those skilled in the art may be used to solve the VMF defined by equation 1 without deviating from the novel scope of the method.

In Step 708, in accordance with one or more embodiments, the plurality of plane-wave CIGs are smoothed by applying a structural oriented smoothing (SOS) to create a plurality of dip-constrained plane-wave CIGs. Application of the SOS may include solving an anisotropic diffusion equation, given by Equation (2) guided by the structural dip and a smoothing factor, SOS is a popular method used in seismic processing that smooths an image along a guidance structure. The guidance structure in this case, is the structural dip determined from Step 706. The gathers are said to be ‘dip-constrained’ because the SOS may be performed guided by the estimated structural dip. The output to SOS, g(x) is a plurality of dip-constrained plane-wave CIGs, which may contain a great reduction in aliasing artifacts, a higher S/N ratio and improved coherency of seismic reflections. Artifacts and noise may bias the extraction of the moveout information. Therefore, by using VMF and SOS together, as described by Steps 706 and 708, the plurality of dip-constrained plane-wave CIGs may be advantageous for performing MVA.

In Step 710, in accordance with one or more embodiments, a plurality of dip-constrained pseudo-angle CIGs (DPACIGs) may be created by applying a non-linear transformation from a plane-index to a pseudo-angle index to the plurality of dip-constrained plane-wave CIGs. The application may be based on the initial seismic velocity model and an application of Snell's law.

Traditional plane-wave CIGs with large surface incident angles propagate in shallow areas effectively and only plane-wave CIGs with small surface incident angles can penetrate at great depths. This usually results in traditional plane-wave CIGs having a narrow coverage in deeper sections, demonstrated in FIG. 6A. To correct for this poor illumination at depth, the plurality of dip-constrained plane-wave CIGs determined from Step 708 are transformed using a non-linear transform to a pseudo angle. Projecting the migrated images from plane-wave index to a pseudo angle index may expand the coverage in deeper areas, as demonstrated in FIG. 6B. The DPACIGs created may be advantageous for performing MVA, particularly in the deeper sections that demonstrate a greater coverage.

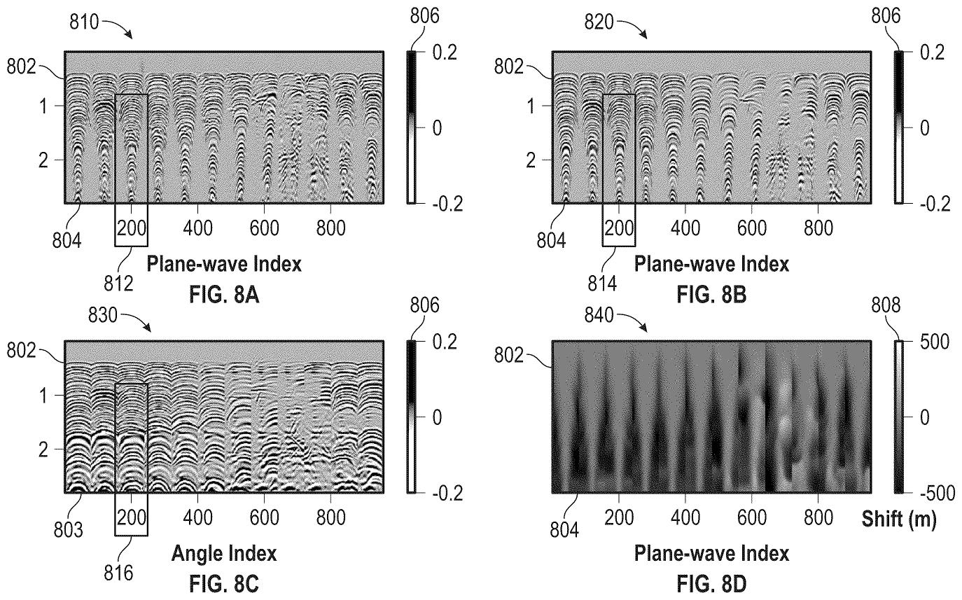

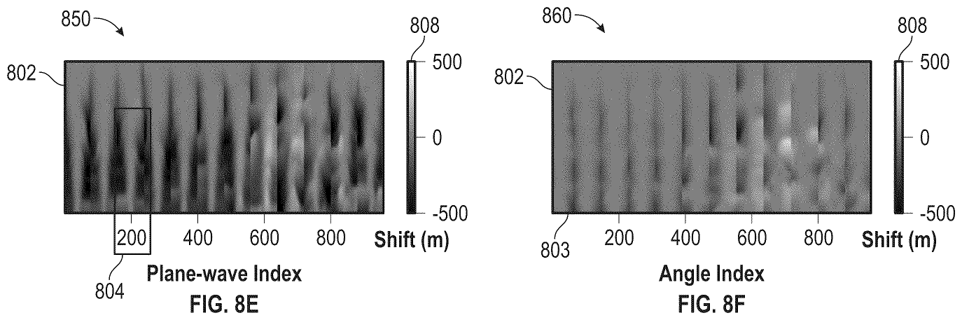

In Step 712, in accordance with one or more embodiments, a migration velocity analysis may be performed on the DPACIGs to pick a residual moveout. MVA is a process where a seismic velocity model may be updated by analyzing the flatness of events recorded in a seismic gather. When determining a residual moveout, a velocity update or a residual moveout is determined that would best flatten the gather. The DPACIGs may be advantageous to determine a residual moveout over other CIGs, due to the improved S/N ratio, the elimination of dip noise in the seismic record, increased coherency of the seismic events and the expanded illumination in the deeper sections. MVA to pick a residual moveout is well known to those skilled in the arts and any method to pick the residual moveout may be used without deviating from the scope of the method. The residual moveout may be picked manually by one skilled in the arts, or any automatic moveout picking algorithm may be used. FIGS. 8A-8F show a residual moveout picked from using 3 different types of CIGs including the novel DPACIGS.

In Step 714, in accordance with one or more embodiments, an updated seismic velocity model may be determined based, at least in part, on the residual moveout. The residual moveout determined from Step 712 represents a shift necessary to correct for an initial seismic velocity model. The residual moveout shift values are added to the initial seismic velocity model to create an updated seismic velocity model. The shift values may be positive to increase the velocity or negative to decrease the velocity in accordance with one or more embodiments. The updated seismic velocity model may be applied to update the DPACIGs to verify the accuracy of the seismic velocity model update. The seismic reflections may be evaluated for a flatness and coherency to determine a successful velocity model update.

In some embodiments, Step 702-714 may be performed iteratively in order to determine the updated seismic velocity model. In these embodiments, a single iteration includes creating the DPACIGs according to Steps 702-710, performing a MVA to pick a residual moveout according to Step 712 and determining an updated seismic velocity model according to Step 714. Once the updated seismic velocity model is created, it is used to create updated DPACIGs for evaluation. The updated DPACIGs are used to evaluate the updated seismic velocity model for accuracy by analyzing the flatness of events. FIGS. 8A-8C illustrate CIGs created to evaluate the updated seismic velocity model. If the updated DPACIGs have not been flattened to a satisfactory level, an additional migration velocity analysis may be performed using the updated DPACIGs to pick a new residual moveout. An updated velocity model may then be created from the new residual moveout and evaluated once again. In some embodiments, Steps 702-714 may be performed iteratively until a certain acceptable flatness metric is achieved. In other embodiments, Steps 702-714 may be performed until the difference between two successive updated seismic velocity models are negligible.

In Step 716, in accordance with one or more embodiments, a seismic image for the subterranean region of interest may be created based, at least in part, on the updated seismic velocity model and the seismic dataset. The seismic dataset may be migrated using the updated seismic velocity model determined in Step 714. By migrating the data with the updated or corrected seismic velocity model, the seismic events will be relocated to their true subsurface positions improving the seismic image of the subterranean region of interest. The migration using the updated seismic velocity model will increase the coherency of the seismic events in the seismic image making it more advantageous for seismic interpretation. The seismic image may aid in decisions as to if and where to drill for hydrocarbons in accordance with one or more embodiments.

In the embodiments described in Steps 702-718, a computer system may be specifically configured for the seismic processing and denoted a seismic processor or a seismic processing system. The seismic image created using the seismic processor, may aid in decisions as to where and if to drill for hydrocarbons based on the seismic interpretation. A seismic interpretation workstation may be configured to accept the seismic image for seismic interpretation in accordance with one or more embodiments.

In Step 718, in accordance with one or more embodiments, a drilling target may be identified within the subterranean region of interest using a seismic interpretation workstation based, at least in part, on the seismic image. The seismic image or its attributes may be used to determine geological properties in order to locate a drilling target within a hydrocarbon reservoir (104). The process of determining geological properties from a seismic image or seismic attribute image is called seismic interpretation.

Often the output of seismic interpretation includes the seismic image, or attribute image, with the interpretation of labelled geological boundaries, faults, drilling hazards, well markers, pore fluid contact levels, gas deposits etc., drawn and annotated on the image. The interpreted seismic image may be used, together with other available information, to determine the location of the drilling target with a high degree of certainty. Further, the interpreted seismic image may be used to determine a drilling target, or locations within a hydrocarbon reservoir (104) for which wellbores may be drilled, safely and economically, to produce the hydrocarbons.

The drilling target may also be determined to avoid any potential drilling hazards which may also be interpreted from the seismic image using the seismic interpretation workstation. The formation of DPACIGs to determine an accurate seismic velocity model, will aid in placing seismic events in their correct positions during a subsequent migration and may make the drilling target more easily identifiable using the seismic interpretation workstation.

In step 720, in accordance with one or more embodiments, a wellbore path may be planned using a wellbore path planning system to intersect the drilling target. Prior to the commencement of drilling, a wellbore plan may be generated. The wellbore plan may include a starting surface location of the wellbore, or a subsurface location within an existing wellbore, from which the wellbore may be drilled. Further, the wellbore plan may include a terminal location that may intersect with the targeted hydrocarbon bearing formation and a planned wellbore path from the starting location to the terminal location. A wellbore planning system may be used to generate the wellbore plan. The wellbore planning system may comprise one or more computer processors in communication with computer memory containing the reservoir model, information relating to drilling hazards, and the constraints imposed by the limitations of the drillstring and the drilling system.

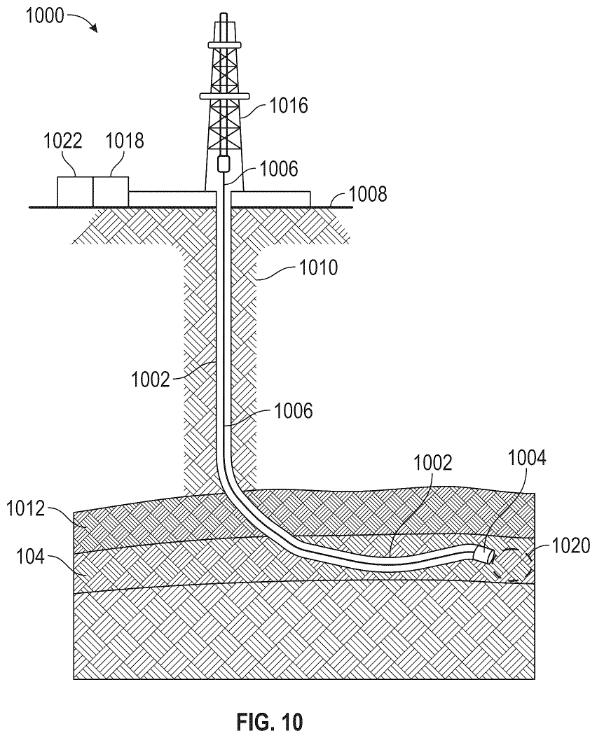

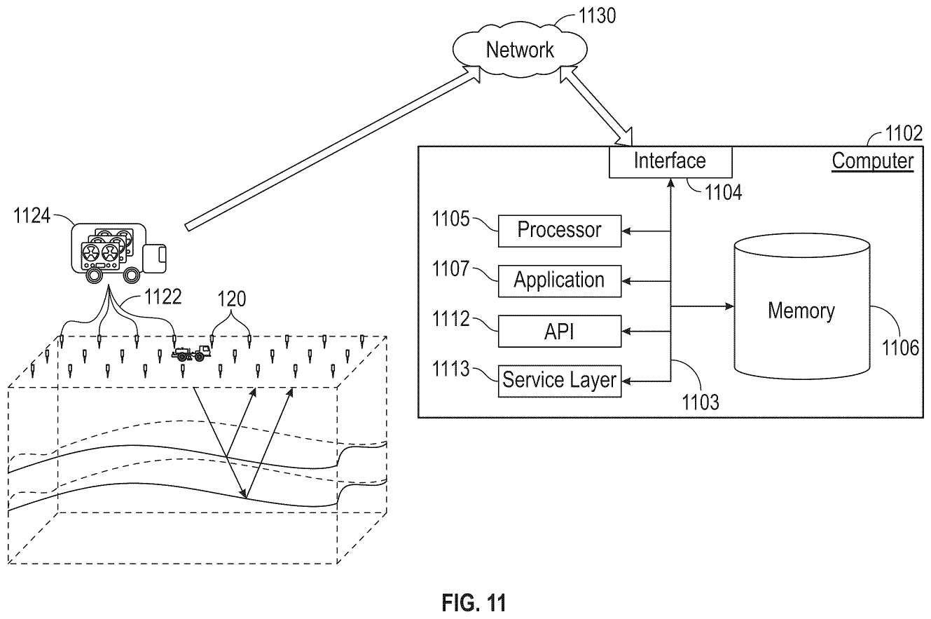

The wellbore path planning system may further include dedicated software to determine the planned wellbore path and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore. A wellbore path planning system is illustrated in FIG. 10.

In Step 722, in accordance with one or more embodiments, a wellbore guided by the wellbore path may be drilled using a drilling system. A wellbore may be drilled by a drill bit, attached by a drillstring, to a drill rig which are all included in a drilling system. The wellbore may traverse a plurality of overburden layers to a drilling target within a hydrocarbon reservoir. The drilling target may be identified based on the seismic image, described in Step 718. The seismic image created using the method described herein may lead to advantageous subterranean interpretation and the determination of a drilling target including a hydrocarbon reservoir. A drilling system may be used to drill a wellbore, guided by the wellbore path to access and extract these hydrocarbons. A drilling system is illustrated and given in more detail in FIG. 10.

FIGS. 8A-8F show three types of CIGs and their associated picked residual moveout in accordance with one or more embodiments. Moveout is a process where a seismic velocity model can be updated, by analyzing the flatness of events recorded in a seismic gather. To demonstrate that the DPACIGs have an advantageous approach to performing MVA over other CIGs, three different gathers are generated and a residual moveout is auto picked. The CIGs were generated using the Marmousi model. The Marmousi model is a complex 2D seismic velocity model widely used to evaluate imaging strategies, as it represents a very geologically complex area and has a set of benchmark seismic images created from a variety of different imaging strategies for comparison purposes. A synthetic dataset has been created using the Marmousi model, and the velocities have been altered to include higher velocities (10% higher than the true velocities) to demonstrate the effectiveness of using DPACIGs over other CIGs to overcome these inaccuracies during MVA.

A plane-wave CIG (810) and a dip-constrained plane-wave CIG (820) are illustrated in FIGS. 8A and 8B respectively. These gathers (810, 820) are displayed on a vertical axis (802) indicating depth and a horizontal axis (804) indicating ray parameter. The dip-constrained plane-wave CIG (820) may be created using Steps 702-708 described herein. FIG. 8C illustrates the novel DPACIGs created using Steps 702-710 described herein. The DPACIG (830) is displayed on a vertical axis (802) indicating depth and a horizontal axis (803) indicating the pseudo-angle. The grayscale (806) represents a normalized amplitude.

FIG. 8D shows the picked residual moveout resulting from performing MVA on the traditional plane-wave CIGs (810), FIG. 8E shows the picked residual moveout using the dip-constrained plane-wave CIGs (820) and FIG. 8F shows the picked residual moveout determined using the novel DPACIGs (830). The picked residual moveouts (840, 850) are displayed on a vertical axis (802) indicating depth and a horizontal axis (804) indicating ray parameter. The residual moveout (860) determined from the DPACIGs (830) is displayed on a vertical axis (802) indicating depth and a horizontal axis (803) indicating the pseudo-angle. The grayscale (808) for the residual moveouts (840, 850, 860) represents a depth shift that ranges between −500 and 500 m.

By examining the box (812), highlighting an area on the plane-wave CIG (810), a low S/N ratio may be observed in addition to sharply curved reflectors and a decreased coverage at depth. These are all characteristic disadvantages exhibited by plane-wave CIGs (810). Likewise, the box (814), highlighting an area on the dip-constrained plane-wave CIG (820) exhibits a similar decreased coverage at depth with sharply dipping reflectors. The dip-constrained plane-wave CIG (814) does however demonstrate an increased S/N ratio when compared to the plane-wave CIG (812). Turning to box (816), highlighting an area on the DPACIGs (830) an increased coverage at depth, a high S/N ratio and a flatter reflector behavior may be noticed. These improvements illustrated by the DPACIGs (830) may be advantageous in determined a residual moveout.

The picked residual moveout values from the three gathers shown in FIG. 8 may not be evaluated alone to determine the effectiveness each gather had on determining a residual moveout. To determine the quality of the picked residual moveouts (840, 850, 860), the original seismic velocity model may be updated with the picked residual moveouts (840, 850, 860) and the CIGs (810, 820,830) may be recreated to evaluate the flattening of the gathers.

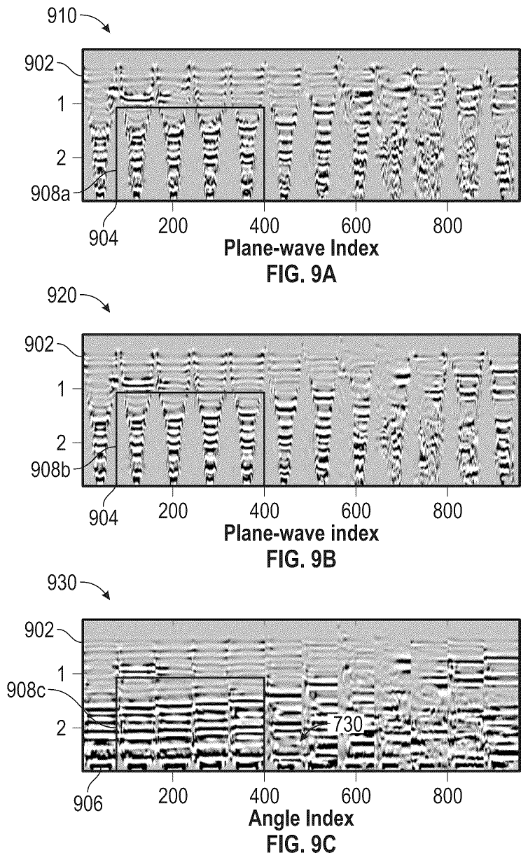

FIG. 9 shows the three types of CIGs (910, 920, 930) with a residual moveout applied in accordance with one or more embodiments. In some embodiments, to evaluate the residual moveouts quickly without dedicating high computational resources to update the velocity model, the depth shift values may be applied to each of the gathers (910, 920, 930) to evaluate the flatness of the gathers. The depth shift values represent the vertical shift for each seismic trace of the gather. The gathers in FIG. 9 (910, 920, 930) have been created by adding the depth shift values determined from the picked residual moveouts (840, 850, 860) to each seismic trace in the gather. FIG. 9A shows plane-wave CIGs (910), determined from applying the residual moveout (840) and FIG. 9B shows dip-constrained plane-wave CIGs (920) determined from the residual moveout (850). These gathers (910, 920) are displayed on a vertical axis (902) indicating depth and a horizontal axis (904) indicating ray parameter. DPACIGs (930) determined from the residual moveout (860) are shown in FIG. 9C. The DPACIG (830) is displayed on a vertical axis (802) indicating depth and a horizontal axis (806) indicating the pseudo-angle.

By evaluating the flatness of the seismic reflectors in the three different types of gathers (910, 920, 930) and in particular in the box highlighting a deeper portion of the CIGs (908a, 908b, 908c) it may be determined that using the DPACIGs for a migration velocity analysis has been the most advantageous. The flatness and coherency of the three gathers shown inside the deeper section (906a, 906b, 906c) are greatly improved when using the DPACIGs for MVA. The novel method to create the DPACIGs from traditional plane-wave CIGs has improved the S/N ratio, increased coherency and flatness of the reflectors, smoothed the gather along guidance structures and expanded the illumination in the deeper sections.

FIG. 10 depicts a drilling system (1000) in accordance with one or more embodiments. As shown in FIG. 10 a well path (1002) may be drilled by a drill bit (1004) attached by a drillstring (1006) to a drill rig (1016) located on the surface of the Earth (1008). The well may traverse a plurality of overburden layers (1010) and one or more cap-rock layers (1012) to a drilling target (1020) within a hydrocarbon reservoir (104). In accordance with one or more embodiments, the seismic image may be used to plan a wellbore path (1002) and drill a wellbore guided by the wellbore path (1002). The well path (1002) may be a curved well path, or a straight well path. All or part of the well path (1002) may be vertical, and some well paths may be deviated or have horizontal sections.

Prior to the commencement of planning a wellbore, the seismic image may be interpreted using the seismic interpretation workstation (1022) to determine a drilling target (1020) based on the seismic image according to Step 718. Seismic interpretation may include manual steps, such as “picking” a sparse set of points on a single interpreted undulating geological boundary, and automatic or algorithmic steps, such as picking all the remaining grid points, intervening between the manually picked points, lying on the boundary using the manually picked points as a guide or “seeds”. In the past, such interpretation was performed using displays of portions of the seismic image printed on paper with the interpretation drawn, originally hand-drawn, on the paper using colored pen or pencils. Now, a seismic interpreter of ordinary skill in the art will, almost without exception, use a seismic interpretation workstation (1022) to perform seismic interpretation.

A seismic interpretation workstation (1022) may include one or more computer processors and a computer-readable memory containing instructions executable by the processor. The computer memory may further contain seismic images and/or seismic attributes. The seismic interpretation workstation (1022) may include a software platform configured to accept multiple types of data including well logs, seismic images, seismic velocity models and geological models. The software platform may aggregate the data from these systems to determine the subsurface location of a drilling target (1020).

The seismic interpretation workstation (1022) may also include a display mechanism, usually one or more monitor screens, but sometimes one or more projector, user-wearable goggles or other virtual reality display equipment and a means of interacting with the display, such as a computer mouse or wand. Further, the seismic interpretation workstation (1022) may include dedicated hardware designed to expedite the rendering and display of the seismic image, images, or attributes in a manner and at a speed to facilitate real-time interaction between the user and the data. For example, the seismic interpretation workstation (1022) may allow the seismic interpreter to scroll through adjacent slices through a 3D seismic image to visually track the continuity of a candidate geological boundary throughout the 3D image. Alternatively, the seismic interpretation workstation (1022) may allow the seismic interpreter to manually control the rotation of the view angle of the seismic image so it may be viewed from above, or from the East or from the West, or from intermediate directions.

As for the seismic interpretation system, the computer processor or processors and computer memory of the seismic interpretation workstation (1022) may be co-located with the seismic interpreter, while in other cases the computer processor and memory may be remotely located from the seismic interpreter, such as on “the cloud.” In the latter case, the seismic or attribute images may only be displayed on a screen, including a laptop or tablet local to the seismic interpreter, who may interact with the computer processor via instructions sent over a network, including a secure network such as a virtual private network (VPN).

Once a drilling target (1020) has been determined from the seismic interpretation and prior to the commencement of drilling, a wellbore plan may be generated using a wellbore path planning system (1018). The wellbore plan may include a starting surface location of the wellbore, or a subsurface location within an existing wellbore, from which the wellbore may be drilled. Further, the wellbore plan may include a terminal location that may intersect with the targeted hydrocarbon bearing formation and a planned wellbore path (1002) from the starting location to the terminal location. In other words, the wellbore path (1002) may intersect a previously located hydrocarbon reservoir (104).

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Furthermore, the wellbore plan may consider other engineering constraints such as the maximum wellbore curvature (“dog-log”) that the drillstring (1006) may tolerate and the maximum torque and drag values that the wellbore drilling system (1000) may tolerate.

In some embodiments, a wellbore path planning system (1018) may be used to generate the wellbore plan based on the drilling target (1020) and an advantageous wellbore path to the drilling target (1020) to extract hydrocarbons. While the seismic interpretation workstation (1022) and the wellbore path planning system (1018) are shown at the drilling location, in some embodiments, the seismic interpretation workstation (1022) and the wellbore path planning system (1018) may be remote from a well site.

The wellbore planning system (1018) may comprise one or more computer processors in communication with computer memory containing geophysical and geomechanical models, information relating to drilling hazards, and the constraints imposed by the limitations of the drillstring (1006) and the drilling system (1000). The wellbore planning system (1018) may further include dedicated software to determine the planned wellbore path (1002) and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore.

A wellbore may be drilled using a drill rig (1016) that may be situated on a land drill site, an offshore platform, such as a jack-up rig, a semi-submersible, or a drill ship. The drill rig (1016) may be equipped with a hoisting system, which can raise or lower the drillstring (1006) and other tools required to drill the well. The drillstring (1006) may include one or more drill pipes connected to form conduit and a bottom hole assembly (BHA) disposed at the distal end of the drillstring (1006). The BHA may include a drill bit (1004) to cut into subsurface rock. The BHA may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore. Both MWD and LWD measurements may be transmitted to the surface (116) using any suitable telemetry system, such as mud-pulse or wired-drill pipe, known in the art.

To start drilling, or “spudding in” the well, the hoisting system lowers the drillstring (1006) suspended from the drill rig (1016) towards the planned surface location of the wellbore. An engine, such as a diesel engine, may be used to rotate the drillstring (1006). The weight of the drillstring (1006) combined with the rotational motion enables the drill bit to bore the wellbore.

The near-surface is typically made up of loose or soft sediment or rock, so large diameter casing, e.g. “base pipe” or “conductor casing,” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface (116) of the earth.

Drilling may continue without any casing once deeper more compact rock is reached. While drilling, drilling mud may be injected from the surface (116) through the drill pipe. Drilling mud serves various purposes, including pressure equalization, removal of rock cuttings, or drill bit cooling and lubrication. At planned depth intervals, drilling may be paused and the drillstring (1006) withdrawn from the wellbore. Sections of casing may be connected and inserted and cemented into the wellbore. Casing string may be cemented in place by pumping cement and mud, separated by a “cementing plug,” from the surface (116) through the drill pipe. The cementing plug and drilling mud force the cement through the drill pipe and into the annular space between the casing and the wellbore wall. Once the cement cures drilling may recommence. The drilling process is often performed in several stages. Therefore, the drilling and casing cycle may be repeated more than once, depending on the depth of the wellbore and the pressure on the wellbore walls from surrounding rock. Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

A drilling system (1000) may be disposed at and communicate with other systems in the well environment. The drilling system (1000) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure WOB (weight on bit), RPM (drill rotational speed), GPM (flow rate of the mud pumps), and ROP (rate of penetration of the drilling operation). Each sensor may be positioned or configured to measure a desired physical stimulus. Drilling may be considered complete when a target zone is reached, or the presence of hydrocarbons is established.

FIG. 11 shows a seismic recording and processing system, in accordance with one or more embodiments. The data recorded by a plurality of seismic receivers (120) may be transmitted to a seismic recording facility (1124) located in the vicinity of the seismic survey. The seismic recording facility (1124) may be one or more seismic recording trucks. The plurality of seismic receivers (120) may be in digital or analogue telecommunication with the seismic recording facility (1124). The telecommunication may be performed over telemetry channels (1122) that may be electrical cables, such as coaxial cables, or may be performed wireless using wireless systems, such as Wi-Fi or Bluetooth. Digitization of the seismic data may be performed at each seismic receiver (120), or at the seismic recording facility (1124), or at an intermediate telemetry node (not shown) between the seismic receiver (120) and the seismic recording facility (1124).

The seismic data may be recorded at the seismic recording facility (1124) and stored on non-transitory computer memory. The computer memory may be one or more computer hard-drives, or one or more computer memory tapes, or any other convenient computer memory media familiar to one skilled in the art. The seismic data may be transmitted to a computer (1102) for processing. The computer (1102) may be located in or near the seismic recording facility (1124) or may be located at a remote location, that may be in another city, country, or continent. The seismic data may be transmitted from the seismic recording facility (1124) to a computer (1102) for processing. The transmission may occur over a network (1130) that may be a local area network using an ethernet or Wi-Fi system, or alternatively the network (1130) may be a wide area network using an internet or intranet service. Alternatively, seismic data may be transmitted over a network (1130) using satellite communication networks. Most commonly, because of its size, seismic data may be transmitted by physically transporting the computer memory, such as computer tapes or hard drives, in which the seismic data is stored from the seismic recording facility (1124) to the location of the computer (1102) to be used for processing.

FIG. 11 further depicts a block diagram of a computer system (1102) used to provide computational functionalities associated with described algorithms, methods, functions, processes, flows, and procedures as described in this disclosure, according to one or more embodiments. For example, the seismic interpretation workstation (1022) and the wellbore path planning system (1018) may be implemented using one or more computer systems such as that illustrated by computer system (1102), as would be understood by those skilled in the art. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130). In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application (for example, executing on another computer (1102) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106) that holds data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining a seismic dataset and an initial seismic velocity model for a subterranean region of interest, wherein the seismic dataset comprises a plurality of plane-wave common-image gathers (CIGs) and each plane-wave CIG comprises a plurality of seismic traces;
stacking the plurality of plane-wave CIGs and estimating a structural dip;
applying a vector median filter (VMF) to attenuate a dip noise contained in the structural dip;
smoothing the plurality of plane-wave CIGs by applying a structural oriented smoothing (SOS) to create a plurality of dip-constrained plane-wave CIGs;
applying a non-linear transform from a plane-index to a pseudo-angle index to the plurality of dip-constrained plane-wave CIGs to create a plurality of dip-constrained pseudo-angle CIGs (DPACIGs);
performing a migration velocity analysis (MVA) on the DPACIGs to pick a residual moveout;
determining an updated seismic velocity model based, at least in part, on the residual moveout; and
creating a seismic image for the subterranean region of interest using the updated seismic velocity model and the seismic dataset.

2. The method of claim 1, further comprising identifying, using a seismic interpretation workstation, a drilling target within the subterranean region of interest based, at least in part, on the seismic image.

3. The method of claim 2, further comprising planning a wellbore path using a wellbore path planning system to intersect the drilling target.

4. The method of claim 3, further comprising drilling a wellbore guided by the wellbore path using a drilling system.

5. The method of claim 1, wherein the structural dip comprises a vector valued local slope of a seismic event and a vector valued dip noise and estimating the structural dip comprises computing a structure tensor.

6. The method of claim 1, wherein applying the vector median filter (VMF) to attenuate the dip noise contained in the structural dip comprises solving a recursive algorithm within a window.

7. The method of claim 1, wherein smoothing the plurality of plane-wave CIGs by applying the SOS to create the plurality of dip-constrained plane-wave CIGs comprises solving an anisotropic diffusion equation guided by the structural dip and a smoothing factor.

8. The method of claim 1, wherein applying the non-linear transform is based on the initial seismic velocity model and an application of Snell's law.

9. A non-transitory computer readable memory, having computer-executable instructions stored thereon that, when executed by a processor, perform steps comprising:
receiving a seismic dataset and an initial seismic velocity model for a subterranean region of interest, wherein the seismic dataset comprises a plurality of plane-wave common-image gathers (CIGs) and each plane-wave CIG comprises a plurality of seismic traces;
stacking the plurality of plane-wave CIGs and estimating a structural dip;
applying a vector median filter (VMF) to attenuate a dip noise contained in the structural dip;
smoothing the plurality of plane-wave CIGs by applying a structural oriented smoothing (SOS) to create a plurality of dip-constrained plane-wave CIGs;
applying a non-linear transform from a plane-index to a pseudo-angle index to the plurality of dip-constrained plane-wave CIGs to create a plurality of dip-constrained pseudo-angle CIGs (DPACIGs);
performing a migration velocity analysis (MVA) on the DPACIGs to pick a residual moveout;
determining an updated seismic velocity model based, at least in part, on the residual moveout;
creating a seismic image for the subterranean region of interest using the updated seismic velocity model and the seismic dataset; and
identifying a drilling target within the subterranean region of interest based, at least in part, on the seismic image.

10. The non-transitory computer readable memory of claim 9, wherein estimating the structural dip comprises computing a structure tensor.

11. The non-transitory computer readable memory of claim 9, wherein the structural dip comprises a vector valued local slope of a seismic event and a vector valued dip noise.

12. The non-transitory computer readable memory of claim 9, wherein applying the vector median filter (VMF) to attenuate the dip noise contained in the structural dip comprises solving a recursive algorithm within a window.

13. The non-transitory computer readable memory of claim 9, wherein smoothing the plurality of plane-wave CIGs by applying the SOS to create the plurality of dip-constrained plane-wave CIGs comprises solving an anisotropic diffusion equation guided by the structural dip and a smoothing factor.

14. The non-transitory computer readable memory of claim 9, wherein applying the non-linear transform is based on the initial seismic velocity model and an application of Snell's law.

15. A system, comprising:
a seismic acquisition system configured to acquire a seismic dataset for a subterranean region of interest, wherein the seismic dataset comprises a plurality of plane-wave common-image gathers (CIGs) and each plane-wave CIG comprises a plurality of seismic traces; and
a seismic processor configured to:
receive the seismic dataset for the subterranean region of interest from the seismic acquisition system;
receive an initial seismic velocity model for the seismic dataset;
stack the plurality of plane-wave CIGs and estimate a structural dip;
apply a vector median filter (VMF) to attenuate a dip noise contained in the structural dip;
smooth the plurality of plane-wave CIGs by applying a structural oriented smoothing (SOS) to create a plurality of dip-constrained plane-wave CIGs;
apply a non-linear transform from a plane-index to a pseudo-angle index to the plurality of dip-constrained plane-wave CIGs to create a plurality of dip-constrained pseudo-angle CIGs (DPACIGs);
perform a migration velocity analysis (MVA) on the DPACIGs to pick a residual moveout;
determine an updated seismic velocity model based, at least in part, on the residual moveout, and
create a seismic image for the subterranean region of interest using the updated seismic velocity model and the seismic dataset; and
a seismic interpretation workstation configured to identify a drilling target within the subterranean region of interest based, at least in part, on the seismic image.

16. The system of claim 15, further comprising further comprising a wellbore path planning system configured to plan a wellbore path to intersect the drilling target.

17. The system of claim 16, further comprising a drilling system to drill a wellbore guided by the wellbore path.

18. The system of claim 15, wherein applying the vector median filter (VMF) to attenuate the dip noise contained in the structural dip comprises solving a recursive algorithm within a window.

19. The system of claim 15, wherein smoothing the plurality of plane-wave CIGs by applying the SOS to create the plurality of dip-constrained plane-wave CIGs comprises solving an anisotropic diffusion equation guided by the structural dip and a smoothing factor.

20. The system of claim 15, wherein applying the non-linear transform is based on the initial seismic velocity model and an application of Snell's law.
